(19) United States
(12) Patent Application Publication
(10) Pub. No.: US 2014/0192866 A1
(43) Pub. Date: Jul. 10, 2014

(54) Data Remapping for Predictive Video Coding

(71) Applicant: Mitsubishi Electric Research Laboratories, Inc., Cambridge, MA (US)

(72) Inventors: Robert A. Cohen, Somerville, MA (US); Anthony Vetro, Arlington, MA (US)

(73) Assignee: Mitsubishi Electric Research Laboratories, Inc., Cambridge, MA (US)

(21) Appl. No.: 14/035,391

(22) Filed: Sep. 24, 2013

Related U.S. Application Data
(60) Provisional application No. 61/750,711, filed on Jan. 9, 2013.

(51) Int. Cl. H04N 7/32

(52) U.S. Cl. CPC H04N 19/00569
USPC 375/240.12

(57) ABSTRACT

Specifically, a method decodes a picture. The picture is encoded and represented by blocks in a bitstream. For each block, a remap flag is obtained from the bit-stream. The block is either a remapped reconstructed block or a non-remapped reconstructed block. Either the non-mapped reconstructed block or an inverse remapped reconstructed block is output according to the remap flag. The remapped reconstructed block maximizes a similarity with the neighboring blocks, as compared to the similarity of the non-mapped reconstructed block and the neighboring blocks, by applying point operations to the remapped reconstructed block.

### RELATED APPLICATION

This Non-Provisional Application claims priority to U.S. Provisional Application Ser. No. 61/750,711, “Data Remapping for Predictive Video Coding,” filed by Cohen et al. on 9 Jan. 2013, which is incorporated herein by reference.

### FIELD OF THE INVENTION

This invention relates generally to video coding, and more particularly to remapping data used during prediction processes.

### BACKGROUND OF THE INVENTION

When videos, images, multimedia or other similar data are encoded or decoded, a set of previously reconstructed blocks of data are used to predict the block currently being encoded or decoded. The set can include one or more previously reconstructed blocks. A difference between a prediction block and the block currently being encoded is a prediction residual block. In the decoder, the prediction residual block is added to a prediction block to form a decoded or reconstructed block.

In an encoder, the prediction residual block is a difference between the prediction block and the corresponding block from the input picture or video frame. The prediction residual block is determined as a pixel-by-pixel difference between the prediction block and the input block. Typically, the prediction residual block is subsequently transformed, quantized, and then entropy encoded for output to a file or bitstream.

In a decoder, the inverse quantized prediction residual block is obtained from the file or bitstream via entropy decoding, inverse quantizing, and inverse transforming. The decoder also determines the prediction block using the set of previously reconstructed blocks as in the encoder. The reconstructed block is determined as a pixel-by-pixel sum of the decoded residual block and the inverse quantized prediction block.

In a typical coding system used to compress data acquired of natural scenes by cameras or sensors, pixels in adjacent blocks are usually better correlated than pixels in distant blocks. The coding system can use the reconstructed pixels in adjacent blocks to predict the current pixels or block. In video coders such as H.264/MPEG-4 AVC (Advanced Video Coding) and High Efficiency Video Coding (HEVC), the current block is predicted using reconstructed blocks adjacent to the current block; namely the reconstructed block above and the reconstructed block to the left of the current block.

Because the current block is predicted using adjacent reconstructed blocks, the prediction is better when the pixels in the current block are highly-correlated to the pixels in the adjacent reconstructed blocks. The prediction process in video coders such as H.264/MPEG-4 AVC and HEVC are optimized to work best when pixels or averaged pixels from the reconstructed block above and to the left can be directionally propagated to the current block. The propagated pixels become the prediction block. However, this prediction fails to perform well when the characteristics of the current block differ greatly from those used for prediction.

FIG. 1 shows a decoder according to conventional video compression standards, such as HEVC. Previously reconstructed blocks 150, typically stored in a memory buffer are fed to a prediction process 160 to generate a prediction block. (PB) 161. The decoder parses and decodes 110 a bitstream 101. followed by an inverse quantization 120 and inverse transform 130 to obtain a quantized prediction residual block 131. The pixels in the prediction block are added 140 to those in the inverse quantized prediction residual block to obtain a reconstructed block 141 for the output video 102, and the set of previously reconstructed block 150 stored in the memory buffer.

While conventional prediction methods can perform well for natural scenes containing soft edges and smooth transitions, those methods are poor at predicting blocks containing sharp edges or strong transitions that are not continuations of edges or transitions in the adjacent blocks used for the prediction. This often occurs when compressing non-natural image and video content, such as images of computer graphics content. Therefore, there is a need for a method that enables directional predictors commonly used in image and video compression systems to Work efficiently with this kind of content.

### SUMMARY OF THE INVENTION

Embodiments of the invention are based on a realization that various encoding/decoding (codec) techniques that use a prediction residual between a current input block and adjacent reconstructed blocks do not produce good results when adjacent reconstructed blocks are different from a current input block for any prediction mode or direction. Therefore, the adjacent reconstructed blocks are not good predictors for the current input block.

However, the same adjacent reconstructed blocks can be good predictors for a remapped. modified current input block. Thus, it can be advantageous to determine the prediction residual block of the remapped current. input block using the adjacent reconstructed blocks, or remapped reconstructed blocks. The prediction residual is quantized, transformed, and signaled in a bitstream for subsequent decoding by the decoder.

The decision whether to remap the current block can be signaled as a remap flag in the bitstream. The prediction residual is determined from the bitstream at the decoder to produce the remapped reconstructed block that corresponds to the remapped current input block, and then depending upon the value of the remap flag, the remapping is reversed to produce the inverse remapped reconstructed block. Other embodiments could be realized without explicitly signaling the remap flag, e.g. by inferring the flag from previously-decoded data.

In various embodiments, the remapping function can be different. For example, one embodiment uses an inverse function for inversion of the pixels values of the current input block before determining the prediction residual. Similarly, the decoder uses the same inverse function to re-invert the values of the pixels. Other functions include linear and nonlinear transforms, filters, subsampling, thresholding, and warping.

Specifically, a method decodes a picture. The picture is encoded and represented by blocks in a bitstream. For each block, a remap flag is obtained from the bit-stream. The block is either a remapped reconstructed block or a non-remapped reconstructed block.

Either the non-mapped reconstructed block or an inverse remapped reconstructed block is output according to the remap flag. The remapped reconstructed block maximizes a similarity with the neighboring blocks, as compared to the similarity of the non-mapped reconstructed block and the neighboring blocks, by applying point operations to the remapped reconstructed block.

Point operations modify the value of a pixel based on that value alone. Example point operations include thresholding or pixel inversion. Changes in brightness or contrast can also be achieved through point operations. In contrast to conventional filtering, which typically involves a weighted average or non-linear operation of multiple neighboring pixels, point operations do not depend on the value of neighboring pixel values, but may depend on other attributes of the image such as the bit depth of a pixel or the maximum intensity value of a pixel.

A coding cost can incorporate the maximization of similarity. Minimizing a coding cost can be equivalent to maximizing similarity or maximizing similarity along with minimizing another metric such as the number of bits used to represent the block m the bitstream.

### BRIEF DESCRIPTION OF THE DRAWINGS

FIG. 1 is a schematic of decoder according to the prior art;

FIG. 2 is a schematic of an encoder according to embodiments of the invention;

FIG. 3 is a schematic of a decoder according to embodiments of the invention;

FIG. 4 is a schematic of a decoder including block analysis according to embodiments of the invention;

FIG. 5 is a schematic of remapping based on previously reconstructed neighboring blocks in an encoder according to embodiments of the invention; and

FIG. 6 is a schematic of inverse r napping in a decoder according to embodiments of the invention.

### DETAILED DESCRIPTION OF THE PREFERRED EMBODIMENTS

### Encoder

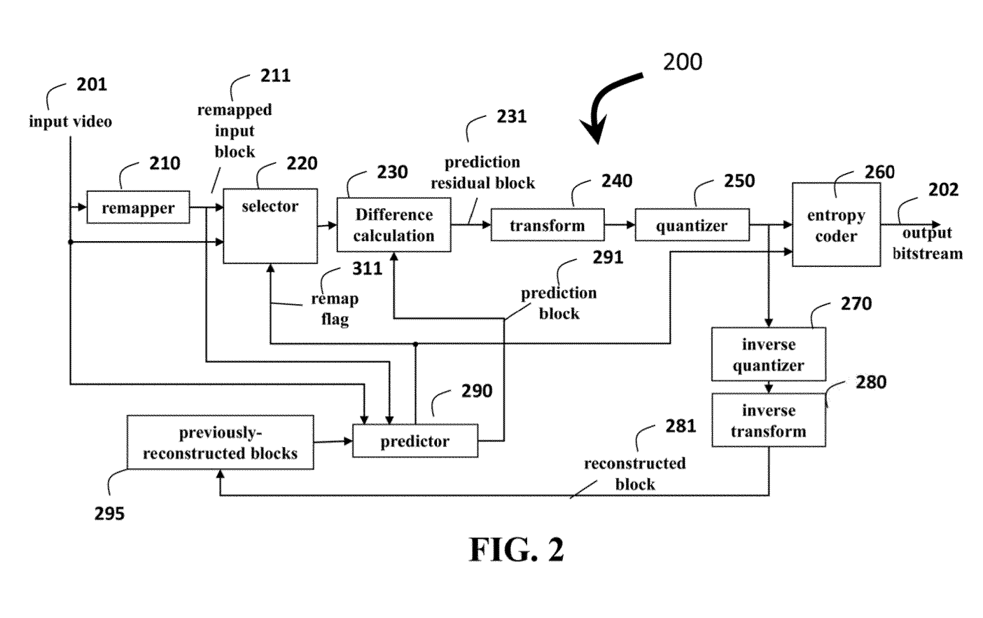

FIG. 2 shows a schematic of an encoder 200 according to the embodiments of the invention. The encoder can be implemented with a processor connected to memory and input/output interlaces by buses as known in the art.

A current block from pictures in an input video 201 to be encoded is input to a remapper 210 to produce a remapped input block 211. The remapped input block and the current input block are input to a selector 220.

A set (one or more) of previously reconstructed blocks 295, are input to a predictor 290 to determine a prediction block 291.

The prediction block is compared to both the current input block and the remapped input block. If the prediction block is similar to the current block, then a remap flag 311 is set to false, and the current block is input to a difference calculation 230. If the prediction block is more similar to the remapped input block, then the remap flag 311 is set to true, for convenience by the predictor 290, and the remapped input block is input to the difference calculation. The measurement of similarity can be performed with a metric, such as minimizing distortion. The other input to the difference calculation is the prediction block 291.

The prediction block is subtracted from either the current input block or the remapped input block, depending upon which of those two blocks were input to the difference calculation. The output of the difference calculation is the prediction residual block 231, which is subsequently transformed 240, quantized 250, and entropy coded 260 for an output bitstream 202.

The transformed, quantized prediction residual block is also inverse quantized 270 and inverse transformed 280 to produce a reconstructed block 281 to be stored in a memory buffer for later use by the predictor 290.

The remap flag 311 is also entropy coded and signaled in the bitstream. Other modes, such as the prediction mode and other data, are also signaled in the bitstream.

### Decoder

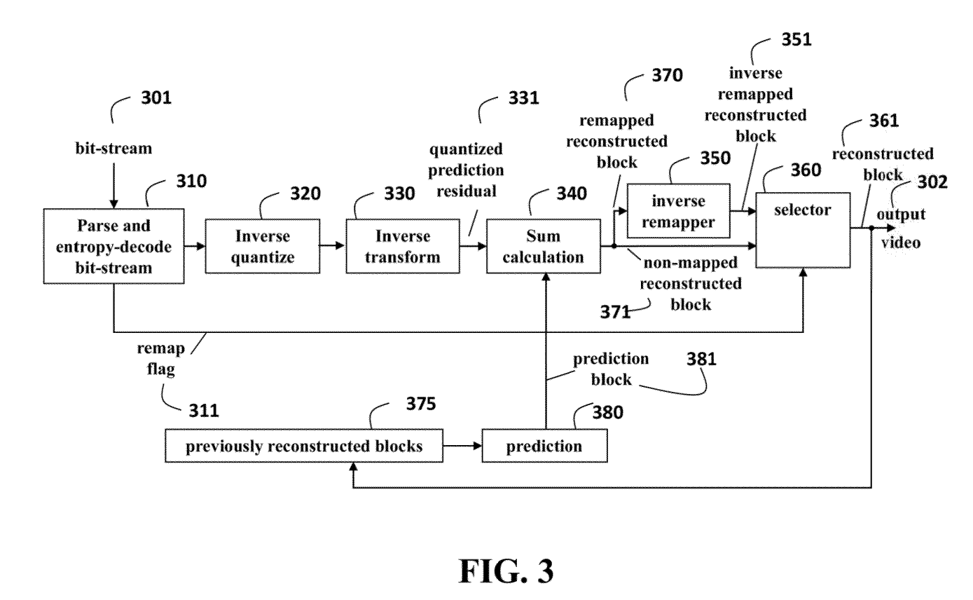

FIG. 3 shows a schematic of a decoder according to embodiments of the invention. The encoder can also be implemented with a processor connected to memory and input/output interfaces by buses known in the art. The decoder can be combined with the encoder of FIG. 2 in a codec (coder/decoder).

The decoder decodes pictures from an input bitstream 301. The decoder parses and decodes 310 the bitstream 301, followed by an inverse quantization 320 and inverse transform 330 to obtain an inverse quantized prediction residual block 331. The pixels in the prediction block and the pixels in the quantized prediction residual block are input to a sum calculation 340, which adds the corresponding pixels in the input blocks to obtain a remapped reconstructed block 370, or a non-mapped reconstructed block 371 which corresponds to a block which was not remapped by the encoder.

The remap flag 311 is also decoded from the bitstream 301. If the value of the remap flag is false, then the remapped reconstructed block 370 is directly output as the reconstructed block 361 for the output video 302. If the value of the remap flag is true, then the output of the remapped reconstructed block is input to the inverse remapper 350 to obtain an inverse remapped reconstructed block 351, which alters the pixels in the block to undo the remapping that was performed in the encoder. The selector 360 select either the output of the inverse remapper or the sum calculation based on the remap flag 311. In some embodiments, the inverse remapper 350 is skipped when its output will not be selected.

The output of the selector is output as the reconstructed block 361 for the output video 302. The reconstructed block is also stored in a memory buffer as one of the previously reconstructed block 375 for later use during prediction 380 by the decoder to obtain the prediction block 381.

Decoder with Block Analysis

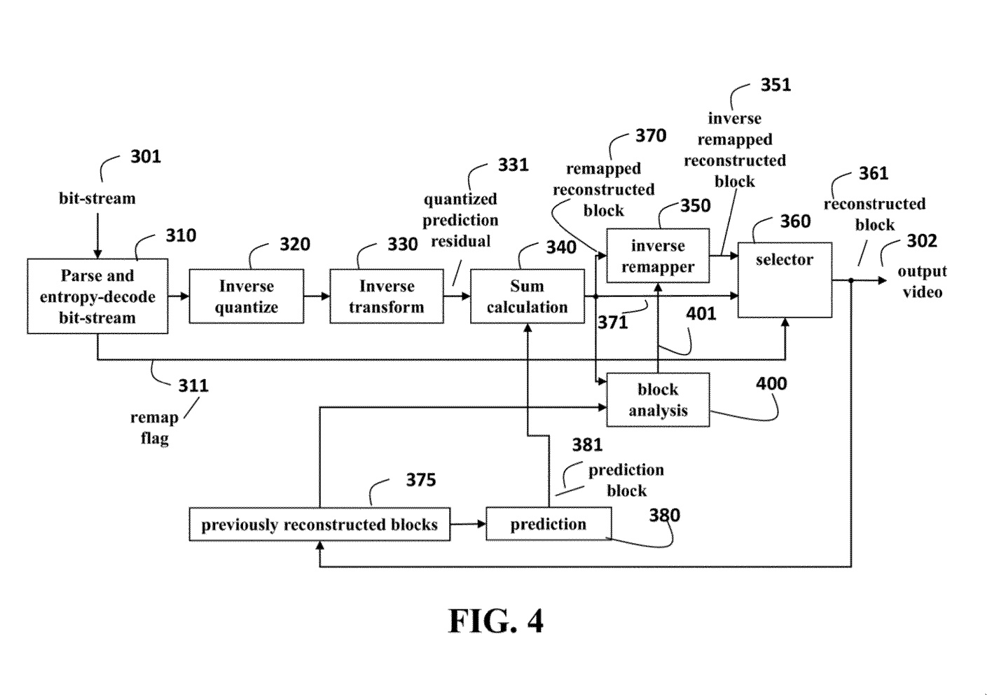

FIG. 4 shows a schematic of a decoder that performs block analysis 400 according to embodiments of the invention. Similar to the decoder of FIG. 3, this also parses and decodes 310 the bitstream 301 followed by the inverse quantization 320 and inverse transform 320 to obtain the quantized prediction residual block 331.

The pixels in the prediction block and the pixels in the quantized prediction residual block are input to the sum calculation 340, which adds the corresponding pixels in the input blocks to obtain a remapped reconstructed block.

The set of previously reconstructed blocks 375 and the remapped reconstructed block 370 are input to a block analysis module 400, which outputs a control signal 401 to the inverse remapper 350. The control signal alters or determines the type of inverse remapping performed on the remapped reconstructed block. The remap flag 311 is also decoded from the bitstream.

If the value of the remap flag is false, then the remapped reconstructed block 370 or the non-mapped reconstructed block 371 is directly output as the reconstructed block for the output video 302. If the value of the remap flag is true, then the output of the remapped reconstructed block is input to the inverse remapper 350 to produce the inverse remapped reconstructed block 351. The inverse remapping alters the pixels in the block to undo the remapping that was performed in the encoder. The output of the inverse remapper is output as the reconstructed block for the output video. The reconstructed block is also stored in memory for later use by the decoder during the prediction 380.

The block analysis module 400 selects or alters the inverse remapping based on the previously reconstructed blocks and the remapped reconstructed block. For example, if the variance of the pixels in the previously reconstructed blocks used in the prediction process is close to the variance of the pixels in the remapped reconstructed block, then the inverse remapper can minimally alter the input data, including not modifying the data at all.

If the variances differ greatly, then the remapper can modify the input data more significantly, using methods such as but not limited to negating the data, filtering, subsampling, or thresholding the data.

### Example Remapping

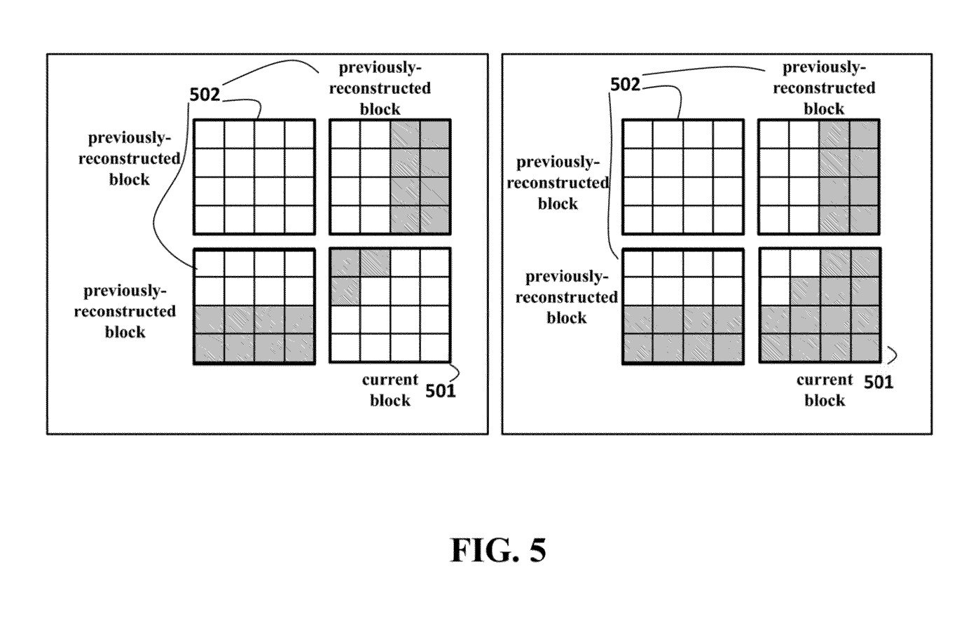

FIG. 5 shows remapping of a current block 501 from previously reconstructed blocks 502 in the encoder. In an example remapping of pixels of a quantized prediction residual block, the current block corresponding to the quantized prediction residual block contains pixels with values resᵢⱼ, where i is an index indicating the horizontal position of the pixel within the block, and j is an index indicating the vertical position of the pixel within the block.

In the decoders of FIG. 3 and FIG. 4, predᵢⱼ, are the pixels corresponding to the prediction block.

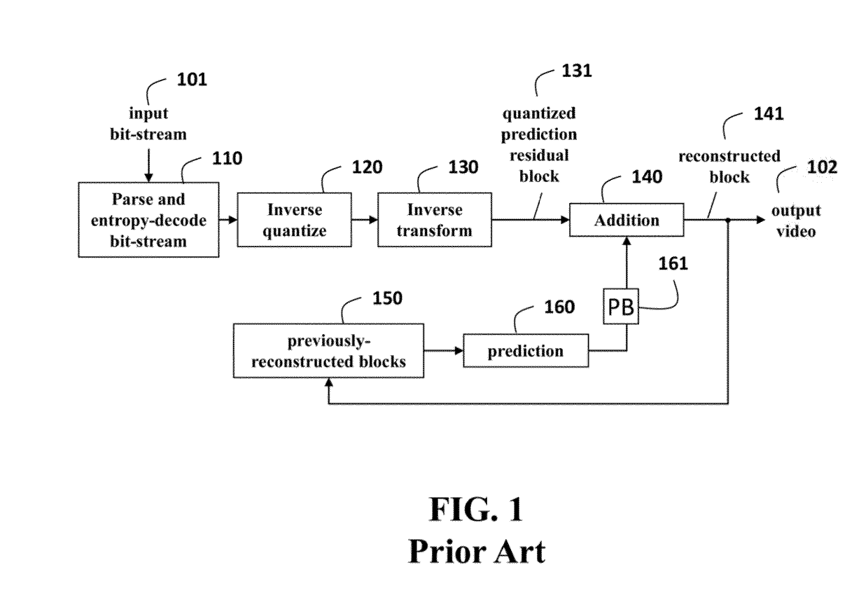

In the prior art decoder of FIG. 1, the pixels in the reconstructed block, recᵢⱼ, are determined by the sum calculation as mrecᵢⱼ=predᵢⱼ+resᵢⱼ.

In the example remapping, pixel intensities can range between 0 and N. The inverse remapper is a function g(x), where g(x)=N−x. The inverse remapper, which determines the final reconstructed block recᵢⱼ, thus determines recᵢⱼ=g(mrecᵢⱼ), which is equivalent to recᵢⱼ=N−mrecᵢⱼ.

### Additional Embodiments

Via arithmetic manipulations, one embodiment can implement the inverse remapper by integrating the remapper with the ^{.}prediction, sum calculator, inverse transform, or inverse quantizer.

The inverse remapper can be located before the sum calculation to alter the quantized prediction residual prior to summation.

There can be more than one inverse remapper, located before and after the sum calculation, or all before the sum calculation.

The block analysis module can also have other inputs, such as the quantized prediction residual or coding modes, settings set in the decoder or parsed from the bitstream.

The inverse remapping g(x) can be g(x)=C−x, where C is a constant.

The inverse remapping g(x) can be g(x)=Iₘₐₓ−x, where Iₘₐₓ is the maximum possible intensity of a pixel in the picture.

The inverse remapping g(x) can be g(x)=C_{b}−x, where C_{b} is a constant value dependent upon the number of hits b used to represent the pixels.

The inverse remapping can be a rotation, flipping, or other rearrangement of pixels in the block. In some embodiments, the remapping function is applied to the current input block. in the encoder and/or output of the sum calculation block in the decoder. Additionally or alternatively, the remapping function and/or the inverse remapper can be applied to other blocks, e.g., to some or all of the previously reconstructed blocks.

The measurement of similarity between a remapped block and the neighboring blocks can be the amount of continuity between structures or texture orientations between the neighboring block and the structures or texture orientations in the remapped block.

For example, if a neighboring block to the left of the current block represents images or video containing horizontally-oriented textures, and if the non-remapped current blocks contains vertical textures, then the remapping can remap the current block so that the current block contains horizontal textures. The inverse remapping restores the horizontal textures back to their original vertical orientation.

The amount of continuity can be measured by computing the signed difference between adjacent pixels of the neighboring block and the current block. If most or all of the magnitudes of the differences along an edge of the block exceed a threshold, and if the signs of the differences are not identical along that edge of the block, that can indicate the presence of a discontinuity in structure across the blocks.

The remapping can then he chosen to remap the current block to minimize the magnitudes or the number of sign differences along that edge. If more or all of the magnitudes of the differences along an edge of the block exceed a threshold, and if the signs of the differences are all the same, then the remapping can be chosen to minimize the magnitude of differences along the edge of the block.

### Method Overview

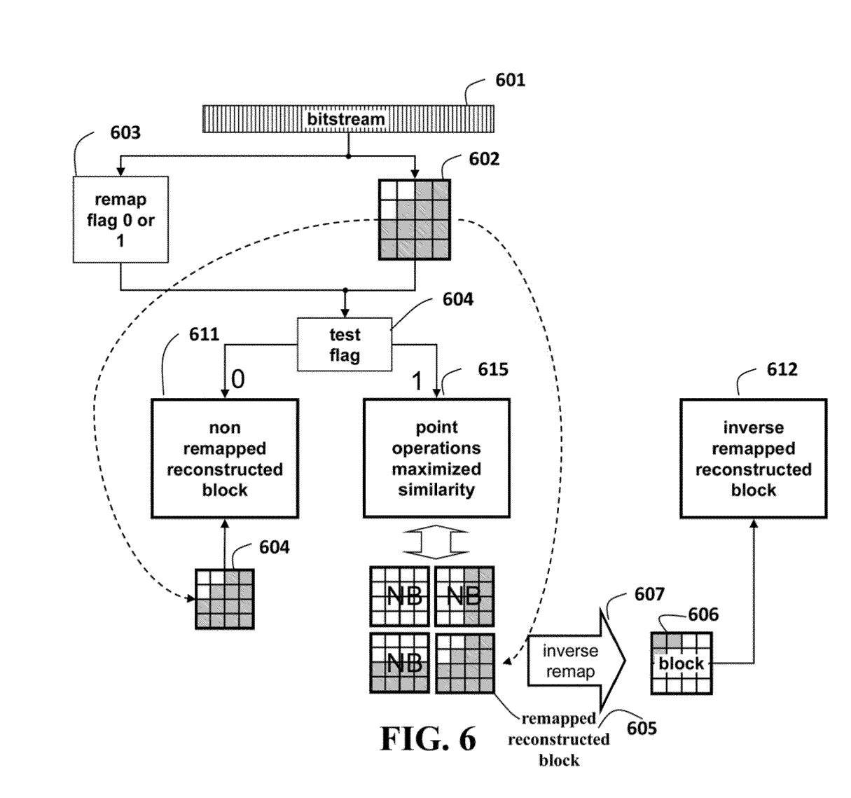

The essential steps of the decoder with inverse remapping is shown in FIG. 6 In this figure, conventional operations such as entropy decoding, inverse quantization, inverse transformation, prediction, etc., are well understood. The remapping and inverse remapping as described herein should not be confused with transformations or other pre- and post-processing steps in conventional codecs.

FIG. 6 shows our method for decoding a picture, wherein the picture is encoded and represented by blocks in a bitstream 601. For each block 602, obtain a remap flag 603 from the bit-stream. The block is either a remapped reconstructed block 605 or a non-remapped reconstructed block 604.

The non-mapped reconstructed block 611 or an inverse 607 remapped reconstructed block 612 is output according to testing 604 of the remap flag. The remapped reconstructed block maximized a similarity with the neighboring reconstructed blocks (NB), (see FIG. 5) as compared to the similarity of the non-mapped reconstructed block and the neighboring reconstructed blocks, by applying point operations 615. It is understood that the point operations are applied to the input block in the encoder according to the flag, and then the decoder uses the same flag to inverse map, or not.

Although the invention has been described by way of examples of preferred embodiments, it is to be understood that various other adaptations and modifications can be made within the spirit and scope of the invention. Therefore, it is the object of the appended s to cover all such variations and modifications as come within the true spirit and scope of the invention.

We claim:

1. A method for decoding a picture, wherein the picture is encoded and represented by blocks in a bitstream, comprising the steps of:
obtaining, for each block, a remap flag from the bit-stream, Wherein the block is either a remapped reconstructed block or a non-remapped reconstructed block; and
selecting, either the non-mapped reconstructed block, or an inverse remapped reconstructed block as a reconstructed block according to the rump flag, wherein the remapped reconstructed block maximized a similarity with neighboring blocks, as compared to the similarity of the non-mapped reconstructed block and the neighboring blocks, by applying point operations to the remapped it reconstructed block, wherein the steps are performed in a decoder.

2. The method of claim. 1, wherein the point operation minimizes a coding cost based on predictions from pixels in the neighboring blocks.

3. The method of claim 1, further comprising:
determining the reconstructed block by combining a prediction residual block with a set of previously reconstructed blocks;
inverse remapping the reconstructed block to produce the inverse remapped reconstructed block; and
storing the inverse remapped reconstructed block for subsequent use by a prediction process.

4. The method of claim 1, wherein the inverse remapped reconstructed block is always used as the reconstructed block.

5. The method of claim 1, further comprising:
combining the set of previously reconstructed blocks and the remapped reconstructed block to determine a type of inverse remapping to perform.

6. The method of claim 5, wherein the set of previously reconstructed blocks is used to determine the type.

7. The method of claim 5, wherein the remapped reconstructed block is used t determine the type.

8. The method of claim 1, wherein the selecting depends on other coding modes.

9. The method of claim 1, wherein the inverse remapping subtracts pixels in the remapped reconstructed block from a constant value.

10. The method of claim 9, wherein the constant value is a maximal possible intensity of the pixels in the picture.

11. The method of claim 9, wherein the constant value is based on a number of bits used to represent the pixels.

12. The method of claim 1, wherein the inverse remapping is a rotation, flipping, or other rearrangement of pixels in the block.

13. The method of claim 1, further comprising:
remapping an input block of an input video to form a remapped block;
selecting the remapped block and the input block as input for a difference calculation; and
subtracting a prediction block to determine a prediction residual block.

14. The method of claim 1, further comprising:
determining the similarity by computing signs and magnitudes of differences between pixels in the blocks and corresponding adjacent pixels along the shared edge in a previously reconstructed block;
comparing the magnitudes of the differences to a threshold;
counting a number of times the signs differ along the shared edge; and
applying an inverse remapping to the block according to the number of times the signs differ.

15. The method of claim 3, wherein the remapped reconstructed blocks is stored as a previously reconstructed block for subsequent use by a prediction process.

16. The method of claim 1, wherein the remapping maximizes a continuity of structure or minimizes differences in texture orientation between the block and adjacent previously-reconstructed blocks.
